(19) United States
(12) Patent Application Publication
(10) Pub. No.: US 2010/0314554 A1
(43) Pub. Date: Dec. 16, 2010

(54) DEVICE TO ILLUMINATE AN OBJECT WITH A MULTISPECTRAL LIGHT SOURCE AND DETECT THE SPECTRUM OF THE EMITTED LIGHT

(76) Inventors: Massimo Galimberti, Turbigo (IT); Francesco Saverio Pavone, Firenze (IT)

Correspondence Address: ABELMAN, FRAYNE & SCHWAB, 666 THIRD AVENUE, 10TH FLOOR, NEW YORK, NY, 10017, US

(21) Appl. No.: 12/744,125

(22) PCT Filed: Nov. 21, 2008
(86) PCT No.: PCT/IB08/54895

§ 371 Date: May 21, 2010

(30) Foreign Application Priority Data
Nov. 21, 2007 (IT) FI2007A000260

(51) Int. Cl. G01N 21/64; G02B 5/18

(52) U.S. Cl. 250/458.1; 359/566; 250/208.1

(57) ABSTRACT

A device to illuminate a object, to excite its fluorescence light emission, and detect the emitted fluorescence spectrum, comprising: at least one illumination system (13), adapted to receive light from a light source (11), to select at least one wavelength bands of light spectrum of the source (11), to illuminate a object (15) with light filtered in that way (14); and a detection system (17), adapted to detect fluorescence light (16) emitted by the object (15), to select at least one wavelength bands of fluorescence, light spectrum (16), to record the spectrum of the filtered light; characterized in that said illumination system (13) comprises: at least one first dispersive element (41), at least one focusing optics (43), at least one spatial fitter of excitation (44), at least one collimating optics (45) and at least one second dispersive element (47), wherein said detection system (17) comprises: at least one dispersive element (81), at least one focusing optics (83), at least one spatial filter of detection (84), at least one imaging optics (85) and at least one light detector (87).

### FIELD OF THE INVENTION

The present invention refers to the field of devices of illumination and detection of light for spectroscopic analysis. In particular the invention applies to samples where different species of fluorescent molecules are present or about which is desirable to have information about the spectrum of the emitted light of fluorescence.

### STATE OF THE ART

At the state of the art there exist many applications in which is required to illuminate a sample at various wavelengths in order to excite the emission of fluorescence by the different types of fluorescent molecules. The spectroscopic analysis of the fluorescence emitted by the sample allows to obtain information related to the number, to the spatial distribution, and to the species of fluorescent molecules.

An example of such application is flow cytometry. In flow cytometry, the sample is illuminated by several lasers at the same time, in order to cause the emission of fluorescence by all the species of fluorescent markers used. To perform the analysis, fluorescent light is collected on several detectors using a combination of dichroic mirrors and chromatic filters. In this way, every detector is specific for a band of wavelengths, characteristic of only one fluorescent marker. The detection system is complicated, expensive, and poorly efficient in terms of intensity of the collected light. Furthermore the whole spectrum of the fluorescence light collected by the detectors is very limited.

A further example is given by spectral confocal microscopy. In this case the sample is illuminated by only one laser at the time. The fluorescence can be analysed, as in the case of flow cytometry, by means of a combination of several detectors, dichroic mirrors and chromatic filters, or by means of a dispersive element and a multichannel detector. In any case, to perform a complete analysis of the fluorescent molecules in the sample, it is necessary in the illumination system go in succession from a laser to a different one. This implies that the images corresponding to different excitation wavelengths are acquired at different times: hence the derivable information from different fluorescent markers are not simultaneous. The switching from an excitation wavelength to a different one can be made in very short time by means of tunable acousto-optic filters, which anyway have a relevant cost.

At the state of the art, polychromatic illumination and spectral detection systems which show both the following characteristics do not exist: simultaneous illumination on several wavelengths; wide spectrum and high spectral resolution detection. Aim of the present invention is the realization of an apparatus for the illumination of an object at several wavelengths at the same time and for the detection of the spectrum of the fluorescence emitted by the object with high spectral resolution and wide bandwidth.

### SUMMARY OF THE INVENTION

The present invention concerns a device able of illuminating an object on several wavelengths at the same time and of detecting the spectrum of the fluorescence emitted by the object with high spectral resolution and wide bandwidth.

### BRIEF DESCRIPTION OF THE DRAWINGS

FIG. 1 illustrates the working scheme of the invention.

FIG. 2 illustrates the working scheme of the invention, with “backward” detection of the fluorescence light.

FIG. 3 illustrates the working scheme of the invention, with a single spatial filter for the detection and for the excitation.

FIG. 4 illustrates the scheme of a first preferred embodiment of the illumination system.

FIG. 5 illustrates the working scheme of the spatial filters of excitation and detection.

FIG. 6 illustrates the scheme of a second preferred embodiment of the illumination system.

FIG. 7 illustrates the scheme of a third preferred embodiment of the illumination system.

FIG. 8 illustrates the scheme of a first preferred embodiment of the detection system.

FIG. 9 illustrates the scheme of a second preferred embodiment of the detection system.

FIG. 10 illustrates the scheme of a third preferred embodiment of the detection system.

FIG. 11 illustrates the scheme of the combined system of illumination and detection, with a single spatial filter.

FIG. 12 illustrates the scheme of a first preferred embodiment of the invention.

FIG. 13 illustrates the scheme of a second preferred embodiment of the invention.

FIG. 14 illustrates the scheme of a third preferred embodiment of the invention, only concerning the illumination system.

### DETAILED DESCRIPTION OF THE INVENTION

The present invention concerns an optical apparatus to illuminate an object and to detect the fluorescence light emitted by the object. The spectrum of excitation light is composed of several bands of wavelengths. As a consequence, it is possible to excite in the object different types fluorescent molecules at the same time. The detection system records the spectrum of the light emitted by the object, after elimination of the spectral components of excitation light.

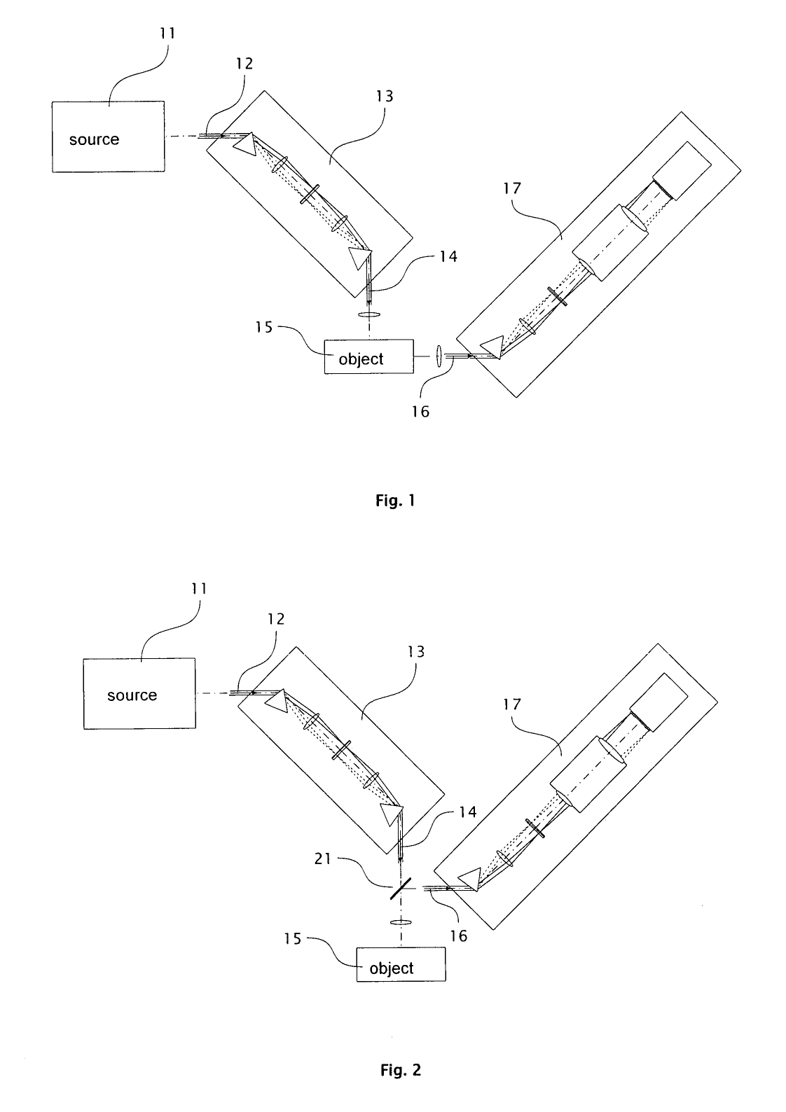

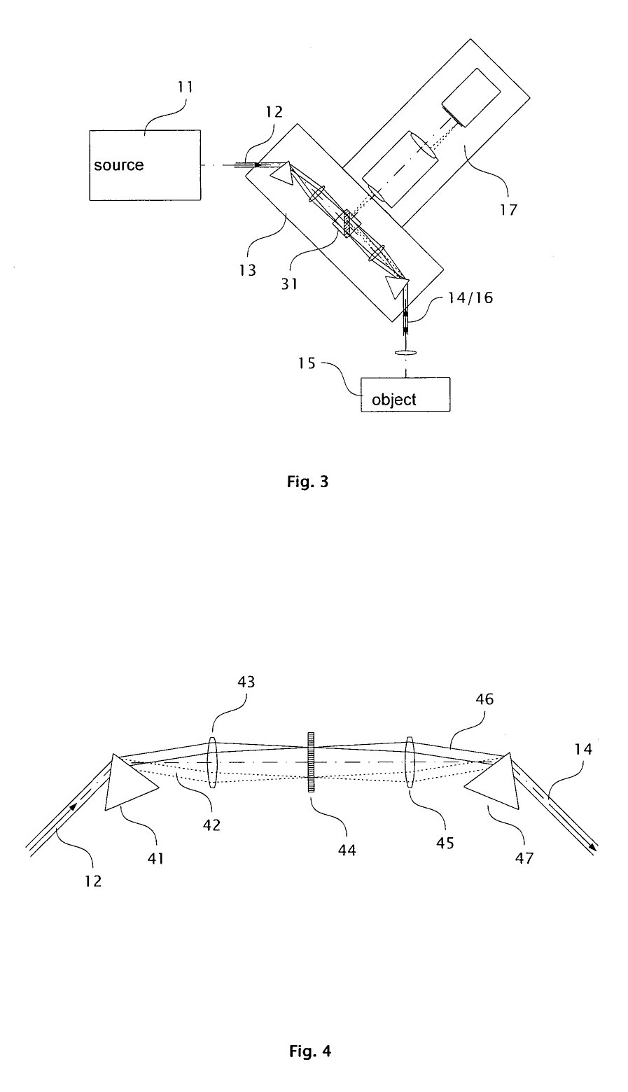

With reference to FIG. 1, the device disclosed by the present invention is composed of an illumination system 13 and of a detection system 17. The illumination system 13 has the function to: take the light 12 from an external polychromatic light source 11; select inside the spectrum of light 12 one or more bands of wavelengths; send this filtered light 14 to the object 15 under examination, in order to excite its emission of fluorescence. The detection system 17 has the function to collect the fluorescence light 16 emitted by the object 15 and to record its spectrum on a detector, after elimination of the spectral components of excitation light 14. With reference to FIG. 2, the detection system 17 can be conveniently placed in order to collect, by means of a beamsplitter 21, the fluorescence light 16 emitted backward by the object 15. With reference to FIG. 3, the illumination system 13 and the detection system 17 can be combined in order to have some common optical element, in particular a single spatial filter 31.

FIG. 4 illustrates the illumination system 13, which is composed of: a first dispersive element 41; a focalisation optic 43; an excitation spatial filter 44; a collimation optic 45; a second dispersive element 47. The first dispersive element 41, constituted by a prism or by a diffraction grating, takes the light 12 coming from a polychromatic source, and disperses its spectral components 42 at different angles. The focalisation optic 43, constituted by one or more lenses, by one or more concave mirrors, or by their combination, focalises every spectral component 42 in a precise point of the excitation spatial filter 44. The excitation spatial filter 44 has the function to select one or more bands of the spectrum of the incident light. The collimation optic 45, constituted by one or more lenses, by one or more concave mirrors, or by their combination, takes the spectral components selected by the excitation spatial filter 44 and collimates them on the second dispersive element 47. The second dispersive element 47, constituted by a prism or by a diffraction grating, operates in a symmetric and opposite manner with respect to the first dispersive element 41, recomposing in a single beam 14 the spectral components 46.

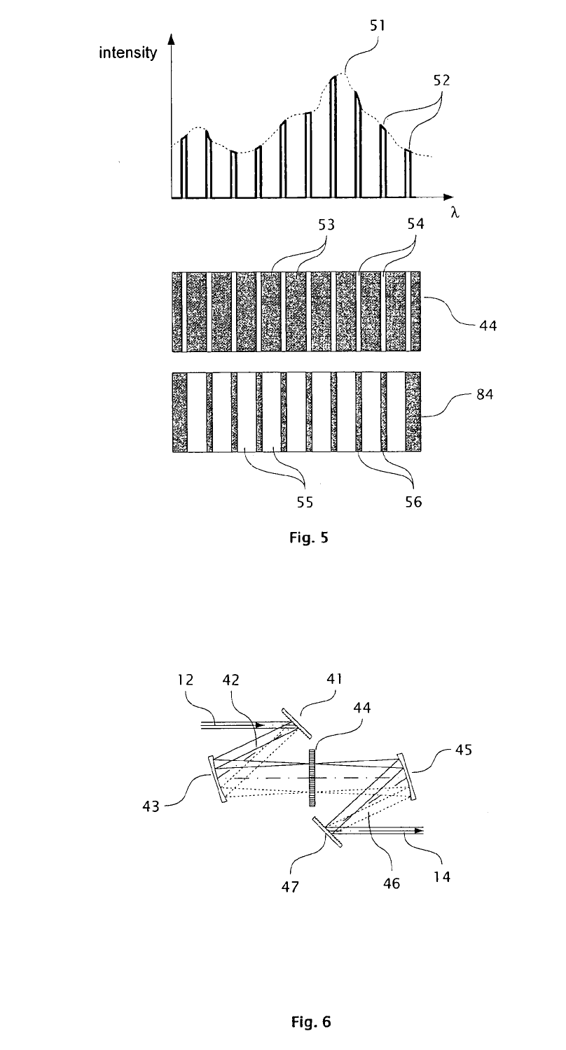

The excitation spatial filter 44 is constituted by a mask which selects by means of transmission or reflection one or more bands of the spectrum of the incident light 12 and extinguishes the other spectral components. FIG. 5 illustrates the structure of the excitation spatial filter 44: it is composed of a series of selection bands 54 alternated with extinction bands 53. In the case that such a filters works in transmission, the selection bands 54 of the mask are transparent and transmit a series of spectral bands 52 of the spectrum 51 of the light source 11. Extinction bands 53 are opaque and extinguish the other spectral components. The transmission mask can be realized by means of: a thin plate of a transparent material, treated in a way that the extinction bands 53 are opaque; a thin opaque plate, with holes along the selection bands 54; a liquid crystal spatial modulator. In the case that the excitation spatial filter 44 works in reflection, the selection bands 54 are reflective. The reflection mask can be realized by means of: a plate treated in a way that only the selection bands 54 are reflective; a liquid crystal spatial modulator; a micro-mirrors digital device, which reflects to the collimation optic 45 the selected spectral components 52, and disperses in other directions the spectral components to extinguish.

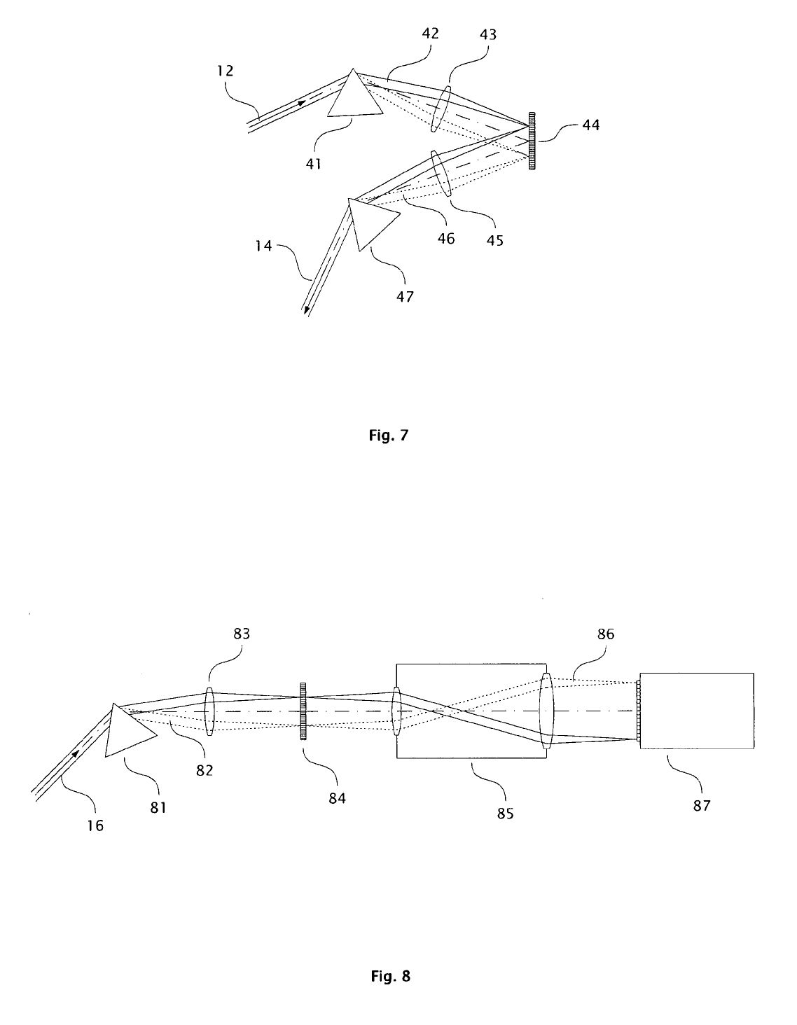

FIGS. 4, 6, 7 illustrate three possible embodiments of the illumination system 13. The FIG. 4 exemplify the illumination system 13 in the case that the excitation spatial filter 44 works in transmission, the dispersive elements 41 and 47 are constituted by prisms, and the focalisation 43 and collimation 45 optics are constituted by lenses. FIG. 6 exemplify the illumination system 13 in the case that the excitation spatial filter 44 works in transmission, the dispersive elements 41 and 47 are constituted by diffraction gratings, and focalisation optics 43 and collimation optics 45 are constituted by concave mirrors. FIG. 7 exemplify the illumination system 13 in the case that the excitation spatial filter 44 works in reflection, the dispersive elements 41 and 47 are constituted by prisms, and focalisation optics 43 and collimation optics 45 are constituted by lenses.

As illustrated in FIG. 8, the detection system 17 is composed of: a dispersive element 81; a focalisation optic 83; a detection spatial filter 84; an imaging system 85; a detector of light 87. The dispersive element 81, constituted by a prism or by a diffraction grating, takes the fluorescence light 16 coming from the object 15, and disperses its spectral components 82 at different angles. The focalisation optic 83, constituted by one or more lenses, by one or more concave mirrors or by their combination, focalises each spectral component 82 in a definite point on the detection spatial filter 84. The detection spatial filter 84 has the function to select one or more bands in the spectrum of fluorescence light 16. The imaging system 85, constituted by one or more lenses, by one or more concave mirrors or by their combination, takes the spectral components selected by the detection spatial filter 84 and focalises them on the detector 87, realizing on it an image of the detection spatial filter 84. The detector of light 87 is a multichannel detector, and can be constituted by a multi-anode photomultiplier tube, by an array of photodiodes, or by a CCD. Every channel of the detector takes the light of a band of the fluorescence spectrum selected by the detection spatial filter 84. In this way it is possible to reconstruct the fluorescence emission spectrum 16 of the object 15.

Similarly to the excitation spatial filter 44, the detection spatial filter 84 is constituted by a mask which selects by means of transmission or reflection one or more bands of the spectrum of the fluorescence light 16 and extinguishes the other spectral components. FIG. 5 illustrates the band structure of the detection spatial filter 84, complementary to that of the excitation spatial filter 44: the selection bands 55 for the detection are placed in correspondence with the extinction bands 53 for the excitation, vice versa the extinction bands 56 for the detection are placed in correspondence with the selection bands 54 for the excitation. Since the excitation light 14 contains the spectral components 52 corresponding to the extinction bands 56 for the detection, the fraction of excitation light eventually collected by the detection system 17 is extinguished by the detection spatial filter 84 and hence is not recorded by the detector 87.

In the case that the detection spatial filter 84 works in transmission, the selection bands 55 of the mask are transparent and transmit a series of spectral bands of the fluorescence light 16 emitted by the object 15. The extinction bands 56 are opaque and extinguish the other spectral components. The transmission mask can be realized with: a thin plate of transparent material, treated in a way that the extinction bands 56 are opaque; a thin opaque plate with holes along the selection bands 55; a liquid crystal spatial modulator.

In the case that the detection spatial filter 84 works in reflection the selection bands 55 are reflective. The reflection mask can be realized by means of: a plate treated in a way that only the selection bands 55 are reflective; a liquid crystal spatial modulator; a micro-mirrors digital device, which reflects to the imaging system 85 the selected spectral components, and disperses in other directions the spectral components to extinguish.

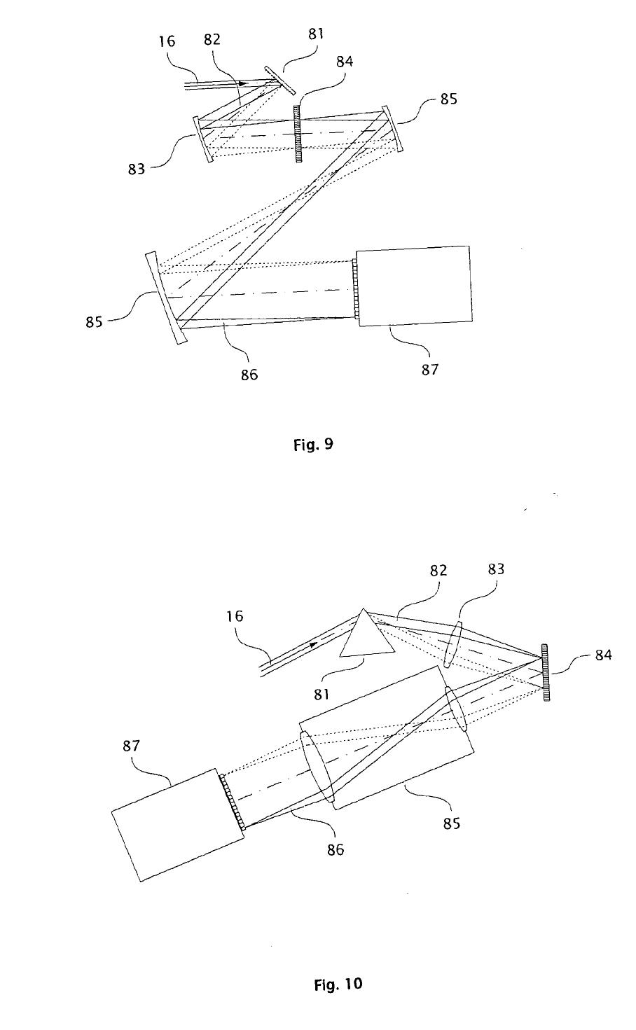

FIGS. 8, 9, 10 illustrate three possible embodiments of the detection system 17. FIG. 8 exemplify the detection system 17 in the case that the detection spatial filter 84 works in transmission, the dispersive element 81 is constituted by a prism, the focalisation optic 83 is constituted by a lens, and the imaging system 85 is constituted by a couple of lenses. FIG. 9 exemplify the detection system 17 in the case that the detection spatial filter 84 works in transmission, the dispersive element 81 is constituted by a diffraction grating, the focalisation optic 83 is constituted by a concave mirror, and the imaging system 85 is constituted by a couple of concave mirrors. FIG. 10 exemplify the detection system 17 in the case that the detection spatial filter 84 works in reflection, the dispersive element 81 is constituted by a prism, the focalisation optic 83 is constituted by a lens and the imaging system 85 is constituted by a couple of lenses.

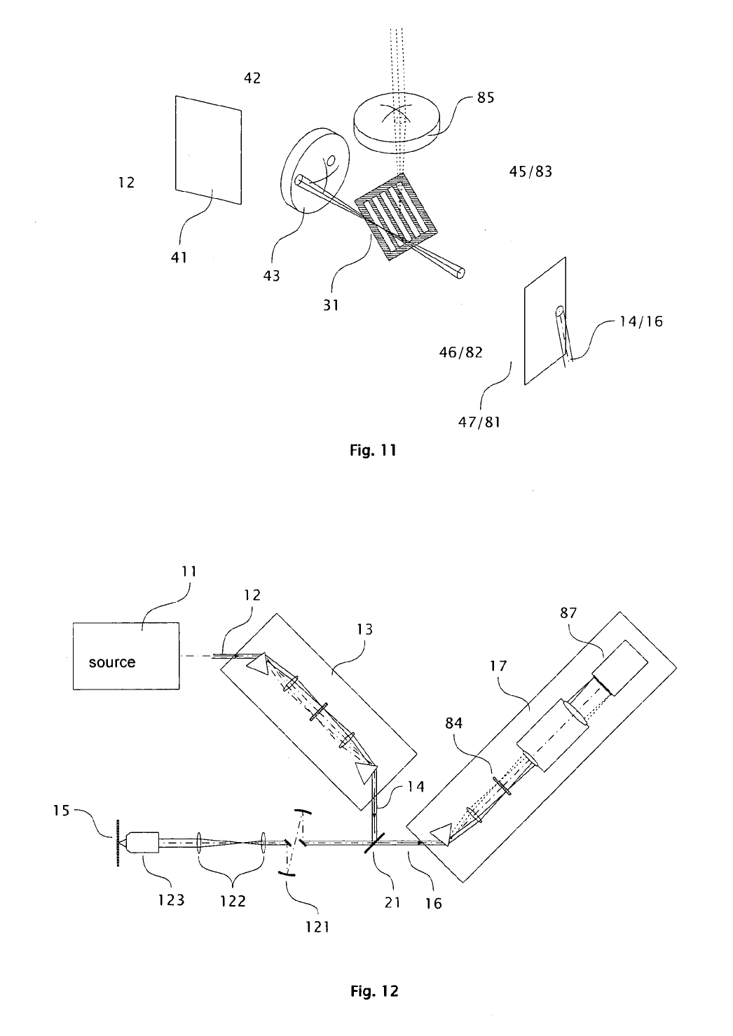

FIG. 11 illustrates the possibility to realize an excitation and detection filter by means of a single element 31, constituted by a mask where the selection bands 54 of the excitation light are transparent, and the selection bands 55 of the fluorescence light are reflective. The filter 31 is tilted in order to reflect the fluorescence light to the imaging system 85, which is part of the detection system 17.

FIG. 12 illustrates the first preferred embodiment of the device according to the present invention, that is multispectral confocal microscope. In this embodiment, that follow the working scheme of the FIG. 2, the excitation light 14 is directed from illumination system 13 by polarizer beamsplitter 21 on the scanning system 121, which shall the scan of object 15 in the object plane. The light 12 that comes from source 11 is conveniently polarized in order to be reflected by polarizer beamsplitter 21. A optics system 122 shall to couple the excitation beam with objective of microscope 123, that focalize the excitation light on a point of object 15. The fluorescence light emitted from object 15 is collected by means of same objective 123, go trough the optics 122 and the scanning system 121, and is partially transmitted by polarizer beamsplitter 21. The detection system 17 collect the reflected fraction of the fluorescence light 16. To obtain the confocality of the apparatus, conveniently can be placed a pinhole along the path between the polarizer beamsplitter 21 and the detection system 17, otherwise a slit in the plane of the spatial filter of detection 84, otherwise a slit in the plane of the detector 87. This embodiment is different from the state of art of the multispectral confocal microscopes because the excitation of the fluorescence happens at the same time on several wavelength, without the need to shift from wavelength to wavelength of the excitation in turn. The image of object 15 is acquired by detector 87 point by point. For each point of the image the detector 87 store the fluorescence emission spectrum 16. The multispectral illumination allow to excite in the object 15 at the same time different type of fluorescent molecules; the recording of the spectrum of the images allow to differentiate the distribution of the different fluorescent molecules in the object 15.

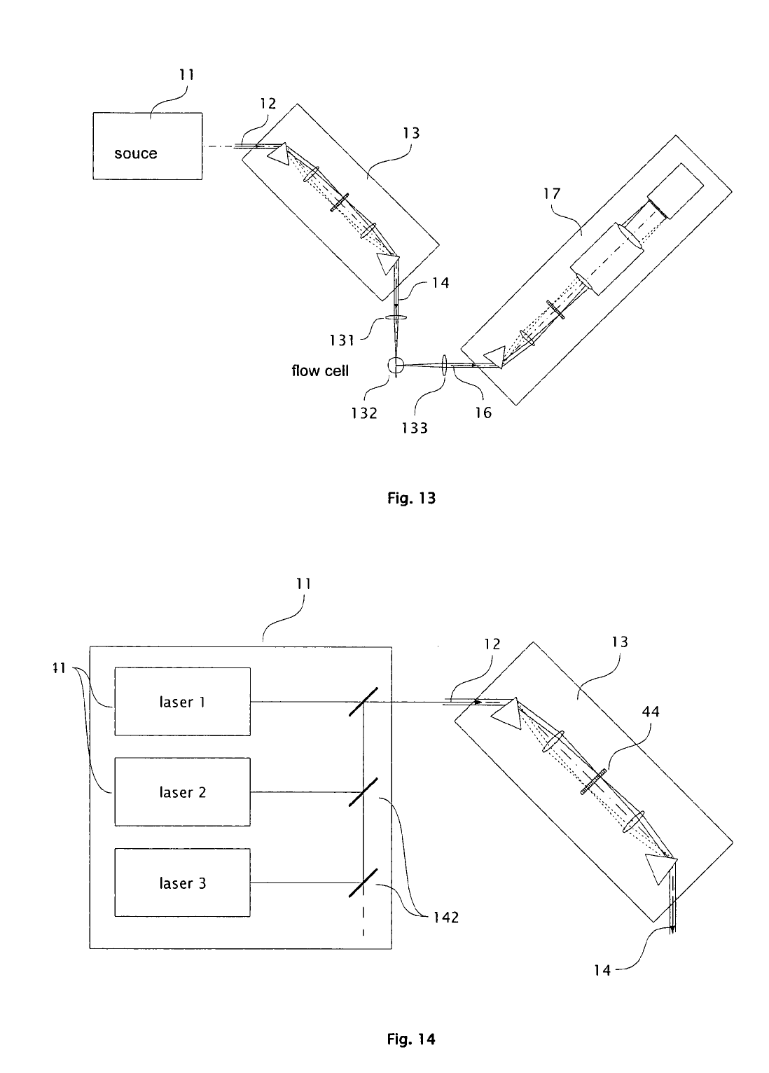

FIG. 13 illustrates the second preferred embodiment of the device according to the present invention, that is flow cytometry apparatus. In this embodiment, that follow the working scheme of the FIG. 1, the excitation light 14 is directed from illumination system 13 on the focusing optics 131, that focuses in the flow cell 132. The emitted fluorescence light 16 from cells that flow in the flow cell 132 is collected by appropriate optics 133 and sent at detection system 17.

This embodiment is different from the state of art of the flow cytometry apparatus because the excitation of fluorescence does not require a complex system of lasers and dichroic mirrors. Moreover the detection system does not require use numerous dichroic mirrors, chromatic filters, and dedicated detectors at specific wavelength. This embodiment allow to excite the fluorescence on several wavelengths at same time with a unique source and in a flexible way: the wavelengths used for the excitation is selected by spatial filter of excitation 44, and can be easy changed replacing the spatial filters or using programmable spatial filters (liquid crystal spatial modulator or digital micromirro device).

FIG. 14 illustrates a third preferred embodiment of the device according to the present invention, only for the part concerning the illumination system 13. In such realization, the polychromatic light source is constituted by several lasers 141, whose beams are superimposed by means of dichroic mirrors 142. In the illumination system 13 the excitation spatial filter 44 is constituted by liquid crystal spatial modulator or by a micro-mirrors digital device. In this way the excitation spatial filter 44 is programmable, that is it is possible to choose every time which bands of wavelengths are selected from the filter. By means of the control electronics of the excitation spatial filter 44, it is possible to fast select which laser beams 141 are selected and illuminate the object 15. The advantage of the present realization with respect to the use of a tunable acousto-optic filter is that several laser at the same time can be sent to the object 15.

1.-34. (canceled)

35. A device to illuminate an object, to excite its fluorescence light emission, and detect the emitted fluorescence spectrum, comprising: at least one illumination system, adapted to receive light from a light source, to select at least one wavelength bands of light spectrum of the source, to illuminate a object with light filtered in that way; and a detection system, adapted to detect fluorescence light emitted by the object, to select at least one wavelength bands of fluorescence light spectrum, to record the spectrum of the filtered light; wherein said illumination system comprises: at least one first dispersive element, at least one focusing optics, at least one spatial filter of excitation, at least one collimating optics and at least one second dispersive element, wherein said detection system comprises: at least one dispersive element, at least one focusing optics, at least one spatial filter of detection, at least one imaging optics and at least one light detector.

36. The device according to claim 35, wherein said first dispersive element of the illumination system comprises a prism or a diffraction grating.

37. The device according to claim 35, wherein said focusing optics of the illumination system comprises a plurality of elements chosen in the group comprising: lenses, concave mirrors.

38. The device according to claim 35, wherein said spatial filter of excitation is adapted to transmit at least one wavelength band of light source.

39. The device according to claim 38, wherein said spatial filter of excitation comprises a plate of transparent material wherein the areas corresponding to wavelength bands of light source that have not to be transmitted are opaque, or a plate of a opaque material, wherein a slit has been engraved in correspondence to each wavelength band of light source that has to be transmitted, or a liquid crystal spatial modulator.

40. The device according to claim 35, wherein said spatial filter of excitation is adapted to reflect at least one wavelength band of light source.

41. The device according to claim 40, wherein said spatial filter of excitation comprises a plate wherein only the areas corresponding to the wavelength bands of the light source that have to be selected, are reflecting, or a liquid crystal spatial modulator or a digital micro-minor device.

42. The device according to claim 35, wherein said collimating optics comprises a plurality of elements chosen in the group comprising: lenses, concave mirrors.

43. The device according to claim 35, wherein said second dispersive element of the illumination system comprises a prism or a diffraction grating.

44. The device according to claim 35, wherein said dispersive element of the detection system comprises a prism or a diffraction grating.

45. The device according to claim 35, wherein said focusing optics of the detection system comprises a plurality of elements chosen in the group comprising: lenses, concave mirrors.

46. The device according to claim 35, wherein said spatial filter of detection is adapted to transmit at least one wavelength band of fluorescence light emitted from object.

47. The device according to claim 46, wherein said spatial filter of detection comprises a plate of a transparent material wherein the areas corresponding at wavelength bands of the fluorescence light that have not to be transmitted are opaque or a plate of an opaque material wherein a slit has been engraved corresponding to each wavelength band of the fluorescence light that have to be transmitted or a liquid crystal spatial modulator.

48. The device according to claim 47, wherein said spatial filter of detection is adapted not to transmit the wavelength bands of the light source selected by the spatial filter of excitation.

49. The device according to claim 35, wherein said spatial filter of detection is adapted to reflect at least one wavelength bands of the fluorescence light emitted from object.

50. The device according to claim 35, wherein said spatial filter of detection comprises a plate wherein only the areas corresponding at the wavelength bands of the fluorescence light that have to be selected, are reflecting or a liquid crystal spatial modulator or a digital micro-mirror device.

51. The device according to claim 48, wherein said spatial filter of detection is adapted not to reflect the wavelength bands of the light source selected by the spatial filter of excitation.

52. The device according to claim 35, wherein said spatial filter of detection and said spatial filter of illumination are coincident in a unique element partially transparent and partially reflecting.

53. The device according to claim 35, wherein said imaging optics comprises a plurality of elements chosen in the group comprising: lenses, concave mirrors.

54. The device according to claims 35, wherein said light detector comprises a multichannel detector adapted to record the fluorescence light spectrum selected by spatial filter of detection, in turn comprising a multi-anode photomultiplier tube or a matrix of photodiode or a CCD.
